(19) United States
(12) Patent Application Publication
(10) Pub. No.: US 2026/0172307 A1
(43) Pub. Date: Jun. 18, 2026

(54) METHOD AND ELECTRONIC DEVICE WITH MULTI-PLANE NETWORK MANAGEMENT

(71) Applicant: Samsung Electronics Co., Ltd., Suwon-si (KR)

(72) Inventors: Kyung-no JOO, Suwon-si (KR); Mincheol KANG, Suwon-si (KR); Kyujin KIM, Suwon-si (KR); Sungjoon PARK, Suwon-si (KR); Changue JUNG, Suwon-si (KR)

(73) Assignee: Samsung Electronics Co., Ltd., Suwon-si (KR)

(21) Appl. No.: 19/227,330

(22) Filed: Jun. 3, 2025

(30) Foreign Application Priority Data
Dec. 18, 2024 (KR) 10-2024-0189593

(51) Int. Cl. H04L 41/0823; H04L 43/0876

(52) U.S. Cl. CPC H04L 41/0823; H04L 43/0876

(57) ABSTRACT

A processor-implemented method includes identifying a characteristic of an application having an execution request, obtaining pieces of plane utilization information of each of planes of a multi-plane network, wherein the pieces of plane utilization information of each of the planes correspond to information related to a utilization state of each of the planes, and switching one or more of the planes to a deactivated state based on either one or both of the identified characteristic and each of the obtained pieces of plane utilization information.

### CROSS-REFERENCE TO RELATED APPLICATIONS

This application claims the benefit under 35 USC § 119(a) of Korean Patent Application No. 10-2024-0189593, filed on Dec. 18, 2024 in the Korean Intellectual Property Office, the entire disclosure of which is incorporated herein by reference for all purposes.

### BACKGROUND

### 1. Field

The following description relates to a method and electronic device with multi-plane network management.

### 2. Description of Related Art

A high-performance computer (HPC) and artificial intelligence performance may be improved with high-bandwidth communication and expandable interconnects.

Peripheral component interconnect express (PCIe) is a standard interface for connecting multiple hardware devices at high speed. PCIe may use a serial communication method in which each hardware device may independently transmit data. PCIe may be used to connect hardware in a personal computer but may also be used in an HPC system due to a high bandwidth and low latency. Multiple hardware devices may be connected through a PCIe switch (i.e., a switch with PCIe applied) and form an expandable fabric network. Through such a fabric network, the performance of an HPC system may be optimized and a large-scale data processing task may be performed more efficiently.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes identifying a characteristic of an application having an execution request, obtaining pieces of plane utilization information of each of planes of a multi-plane network, wherein the pieces of plane utilization information of each of the planes correspond to information related to a utilization state of each of the planes, and switching one or more of the planes to a deactivated state based on either one or both of the identified characteristic and each of the obtained pieces of plane utilization information.

The method may include determining whether pieces of plane utilization information of each of planes in an activated state are greater than or equal to a first threshold value, and switching a plane in a deactivated state to an activated state in response to plane utilization information of one or more of the planes in the activated state being greater than or equal to the first threshold value.

The switching of the one or more of the planes may include determining whether the each of the obtained pieces of plane utilization information is less than a second threshold value, and switching, to the deactivated state, a plane having plane utilization information that is less than the second threshold value.

The characteristic may include a required bandwidth of the application, and the switching of the one or more of the planes may include switching the one or more of the planes to the deactivated state in response to the required bandwidth being less than a threshold bandwidth.

The characteristic may include an amount of network loads of the application, and the switching of the one or more of the planes may include switching the one or more of the planes to the deactivated state in response to the amount of network loads being less than or equal to an amount of threshold loads.

The method may include transmitting the each of the obtained pieces of plane utilization information to a node in an electronic device.

The node may be configured to select a plane among the planes using each of received pieces of plane utilization information and configured to transmit data to other nodes in the electronic device through the selected plane.

The obtaining of the pieces of plane utilization information may include receiving, from switches of each of the planes, pieces of switch utilization information of each of the switches of each of the planes, and determining the pieces of plane utilization information of each of the planes based on the pieces of switch utilization information of each of the switches of each of the planes.

The pieces of switch utilization information of each of the switches of each of the planes may be determined based on a sum of amounts of data transmitted by each of the switches of each of the planes through ports during a predetermined period and a sum of bandwidths of the ports.

The obtaining of the pieces of plane utilization information may include obtaining, from other switches in the same plane, pieces of switch utilization information by a first switch of each of the planes, and determining the pieces of plane utilization information of each of the planes by the first switch of each of the planes by using switch utilization information of the first switch of each of the planes and the pieces of switch utilization information of the other switches in the same plane.

In one or more general aspects, an electronic device includes one or more processors configured to identify a characteristic of an application having an execution request, obtain pieces of plane utilization information of each of planes of a multi-plane network, wherein the pieces of plane utilization information of each of the planes correspond to information related to a utilization state of each of the planes, and switch one or more of the planes to a deactivated state based on either one or both of the identified characteristic and each of the obtained pieces of plane utilization information.

The one or more processors may be configured to determine whether pieces of plane utilization information of each of planes in an activated state are greater than or equal to a first threshold value, and switch a plane in a deactivated state to an activated state in response to plane utilization information of one or more of the planes in the activated state being greater than or equal to the first threshold value.

For the switching of the one or more of the planes, the one or more processors may be configured to determine whether the each of the obtained pieces of plane utilization information is less than a second threshold value, and switch, to the deactivated state, a plane having plane utilization information that is less than the second threshold value.

The characteristic may include a required bandwidth of the application, and, for the switching of the one or more of the planes, the one or more processors may be configured to switch the one or more of the planes to the deactivated state in response to the required bandwidth being less than a threshold bandwidth.

The characteristic may include an amount of network loads of the application, and, for the switching of the one or more of the planes, the one or more processors may be configured to switch the one or more of the planes to the deactivated state in response to the amount of network loads being less than or equal to an amount of threshold loads.

The one or more processors may be configured to transmit the each of the obtained pieces of plane utilization information to a node in the electronic device.

The node may be configured to select a plane among the planes using each of received pieces of plane utilization information and transmit data to other nodes in the electronic device through the selected plane.

For the obtaining of the pieces of plane utilization information, the one or more processors may be configured to receive, from switches of each of the planes, pieces of switch utilization information of each of the switches of each of the planes and configured to determine the pieces of plane utilization information of each of the planes based on the pieces of switch utilization information of each of the switches of each of the planes.

The pieces of switch utilization information of each of the switches of each of the planes may be determined based on a sum of amounts of data transmitted by each of the switches of each of the planes through ports during a predetermined period and a sum of bandwidths of the ports.

For the obtaining of the pieces of plane utilization information, a first switch of each of the planes may be configured to obtain, from other switches in the same plane, pieces of switch utilization information and configured to determine the pieces of plane utilization information of each of the planes by the first switch of each of the planes by using switch utilization information of the first switch of each of the planes and the pieces of switch utilization information of the other switches in the same plane.

Other features and aspects will be apparent from the following detailed description, the drawings, and the claims.

### BRIEF DESCRIPTION OF THE DRAWINGS

FIG. 1 illustrates an example of an electronic device.

FIG. 2 illustrates an example of an electronic device.

FIG. 3 illustrates an example of planes in an electronic device.

FIGS. 4 and 5 illustrate examples of an electronic device collecting pieces of plane utilization information.

FIGS. 6 and 7 illustrate examples of an electronic device collecting pieces of plane utilization information.

FIG. 8 illustrates an example of an operation of an electronic device activating planes.

FIG. 9 illustrates an example of an operation of an electronic device activating and deactivating planes.

FIGS. 10 and 11 illustrate examples of an operation of a node in an electronic device.

FIG. 12 illustrates an example of an operating method (or a multi-plane network management method) of an electronic device.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Hereinafter, examples will be described in detail with reference to the accompanying drawings. When describing the examples with reference to the accompanying drawings, like reference numerals refer to like elements and a repeated description related thereto will be omitted.

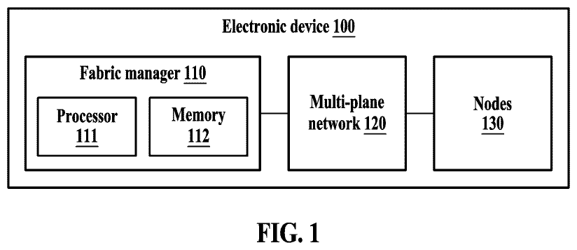

FIG. 1 illustrates an example of an electronic device.

Referring to FIG. 1, an electronic device 100 may include a fabric manager 110, a multi-plane network 120, and a plurality of nodes 130.

The electronic device 100 may include various electronic devices, such as, for example, a high-performance computer (HPC), a supercomputer, and/or a server computer.

The electronic device 100 of FIG. 1 includes one fabric manager 110, but this is only an example, and the electronic device 100 may include a plurality of fabric managers. Instead of the electronic device 100 including the fabric manager 110, at least one of the nodes 130 may perform an operation of the fabric manager 110.

The fabric manager 110 may manage the multi-plane network 120. For example, the fabric manager 110 may manage the multi-plane network 120 at the plane level by controlling switches forming each plane of the multi-plane network 120. The fabric manager 110 may monitor the utilization state of each plane in the multi-plane network 120 and may control each plane. For example, the fabric manager 110 may determine whether to activate each plane.

The fabric manager 110 may correspond to (e.g., may be or include) a hardware device including a processor 111 (e.g., one or more processors) and a memory 112 (e.g., one or more memories). The processor 111 may perform overall functions for controlling the fabric manager 110. The processor 111 may control overall operations of the fabric manager 110 by executing programs and/or instructions stored in the memory 112. For example, the memory 112 may be or include a non-transitory computer-readable storage medium storing code that, when executed by the processor 111, configures the processor 111 to perform any one, any combination, or all of operations and/or methods disclosed herein with reference to FIGS. 1-12. The processor 111 may be implemented as a central processing unit (CPU), a graphics processing unit (GPU), an application processor (AP), and/or the like, but is not limited thereto. The memory 112 may be hardware storing data processed and/or data to be processed within the fabric manager 110. In addition, the memory 112 may store applications, drivers, and the like to be driven by the fabric manager 110. The memory 112 may include volatile memory such as dynamic random access memory (DRAM) and/or nonvolatile memory.

The multi-plane network 120 may include a plurality of planes (or plane networks). A plane (or a plane network) may be a network used when the electronic device 100 transmits data of a node to other nodes and may be independent from other planes. The planes in the multi-plane network 120 may not be connected to each other, and each plane may correspond to an independent network. Each of the nodes 130 may include a plurality of network interface cards (NICs), and the multi-plane network 120 may refer to a network including an independent network (e.g., a plane) through each NIC. Each of the nodes 130 may achieve a high bandwidth by transmitting data through a plurality of ports.

Each of the nodes 130 may transmit and receive data and perform a computation. The nodes 130 may be connected to the multi-plane network 120 and may transmit and receive data through at least one of or all the planes in the multi-plane network 120. Each of the nodes 130 may be expressed differently as a computing device, a processing device, etc. Each of the nodes 130 may include, for example, a graphics processing unit (GPU), a neural processing unit (NPU), and/or a system-on-chip (SoC). Each of the nodes 130 may be expressed as an endpoint.

As described below, the fabric manager 110 may deactivate some of the planes based on at least one of pieces of plane utilization information of each of the planes and/or a characteristic of an application (e.g., a required bandwidth of an application and/or the amount of network loads of the application). The required bandwidth of the application (e.g., a bandwidth used to execute or implement the application) may include, for example, a network bandwidth to be used for the execution of the application. The amount of network loads of the application may include, for example, the amount of loads that the application may generate in a network (e.g., at least one of the planes). The fabric manager 110 may adjust the number of active planes based on the pieces of plane utilization information of each of the planes and/or the characteristic of the application. Accordingly, the fabric manager 110 of one or more embodiments may reduce the power consumption of the electronic device 100 while maintaining the performance of the electronic device 100 and/or the performance of the network (e.g., the multi-plane network 120).

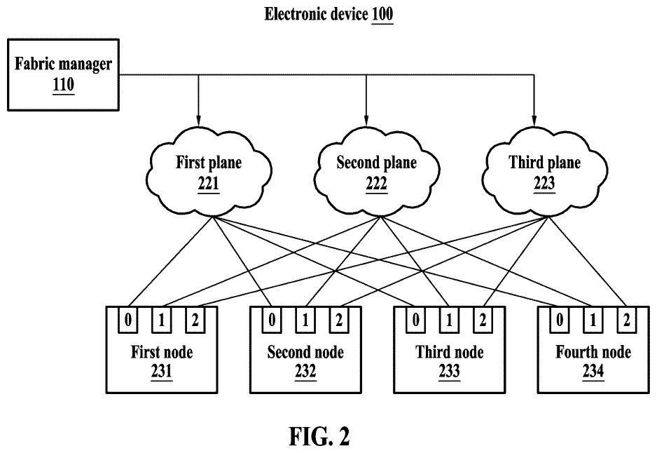

FIG. 2 illustrates an example of an electronic device.

Referring to FIG. 2, the electronic device 100 may include the fabric manager 110, a plurality of planes (e.g., a first plane 221, a second plane 222, and a third plane 223), and a plurality of nodes (e.g., a first node 231, a second node 232, a third node 233, and a fourth node 234).

In the example illustrated in FIG. 2, each of the first, second, third, and fourth nodes 231, 232, 233, and 234 may include a plurality of ports (e.g., port 0, port 1, and port 2). Each of the first, second, third, and fourth nodes 231, 232, 233, and 234 may be connected to the first plane 221 through the port 0 of each of the first, second, third, and fourth nodes 231, 232, 233, and 234. Each of the first, second, third, and fourth nodes 231, 232, 233, and 234 may be connected to the second plane 222 through the port 1 of each of the first, second, third, and fourth nodes 231, 232, 233, and 234. Each of the first, second, third, and fourth nodes 231, 232, 233, and 234 may be connected to the third plane 223 through the port 2 of each of the first, second, third, and fourth nodes 231, 232, 233, and 234.

The number of ports of each of the first, second, third, and fourth nodes 231, 232, 233, and 234 of FIG. 2 may be 3, but this is only an example, and the number of ports of each of the first, second, third, and fourth nodes 231, 232, 233, and 234 may be greater than or less than 3, according to other non-limiting examples.

Although 3 planes and 4 nodes are illustrated in FIG. 2, this is only an example, and the number of planes included in the electronic device 100 may be greater than or less than 3, and the number of nodes included in the electronic device 100 may be greater than or less than 4, according to other non-limiting examples.

Each of the first, second, and third planes 221, 222, and 223 may correspond to an independent network. That is, each of the first, second, and third planes 221, 222, and 223 may not directly communicate with other planes (e.g., may not directly communicate with each other).

The communication protocols supported by each of the first, second, and third planes 221, 222, and 223 may be the same. For example, the first, second, and third planes 221, 222, and 223 may support peripheral component interconnect express (PCIe). Switches included in each of the first, second, and third planes 221, 222, and 223 may support PCIe. Depending on the implementation, the communication protocol supported by at least one of the first, second, and third planes 221, 222, and 223 may be different from the communication protocols supported by other planes. For example, the first plane 221 and the third plane 223 may support PCIe, and the second plane 222 may support Ethernet.

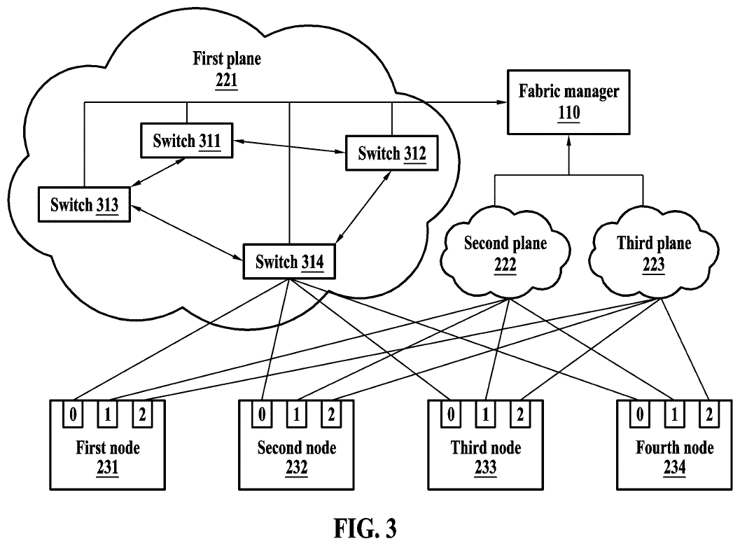

FIG. 3 illustrates an example of planes in an electronic device.

Referring to FIG. 3, the first plane 221 may include a plurality of switches 311, 312, 313, and 314. Each of the switches 311, 312, 313, and 314 may correspond to a switch supporting PCIe, for example, but is not limited thereto. The description of the first plane 221 may be applied to the second plane 222 and the third plane 223.

Each of the switches 311, 312, 313, and 314 of the first plane 221 may be connected to the fabric manager 110. The fabric manager 110 may deactivate the first plane 221 by turning off the switches 311, 312, 313, and 314. The fabric manager 110 may activate the first plane 221 by turning on the switches 311, 312, 313, and 314.

Although not illustrated in FIG. 3, the second plane 222 and the third plane 223 may include a plurality of switches. Each of the switches of the second plane 222 may be connected to the fabric manager 110. The fabric manager 110 may deactivate the second plane 222 by turning off the switches of the second plane 222 and may activate the second plane 222 by turning on the switches of the second plane 222. Similarly, each of the switches of the third plane 223 may be connected to the fabric manager 110. The fabric manager 110 may deactivate the third plane 223 by turning off the switches of the third plane 223 and may activate the third plane 223 by turning on the switches of the third plane 223.

In the example illustrated in FIG. 3, the switch 314 may form a connection (e.g., an electrical connection) with the port 0 of each of the first, second, third, and fourth nodes 231, 232, 233, and 234. Although not illustrated in FIG. 3, each of the other switches 311, 312, and 313 may form a connection (e.g., an electrical connection) with other nodes (not shown) of the electronic device 100.

Although not illustrated in FIG. 3, a certain switch in the second plane 222 may form a connection (e.g., an electrical connection) with the port 1 of each of the first, second, third, and fourth nodes 231, 232, 233, and 234. A certain switch in the third plane 223 may form a connection (e.g., an electrical connection) with the port 2 of each of the first, second, third, and fourth nodes 231, 232, 233, and 234.

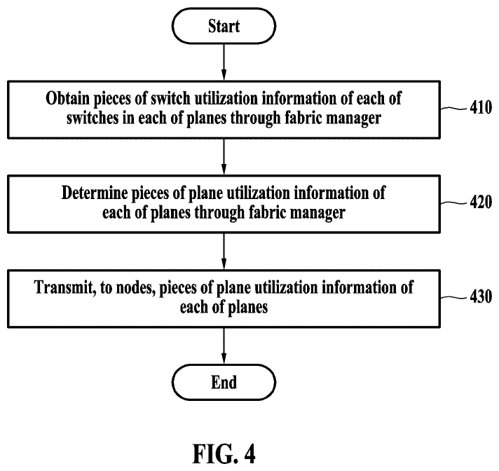

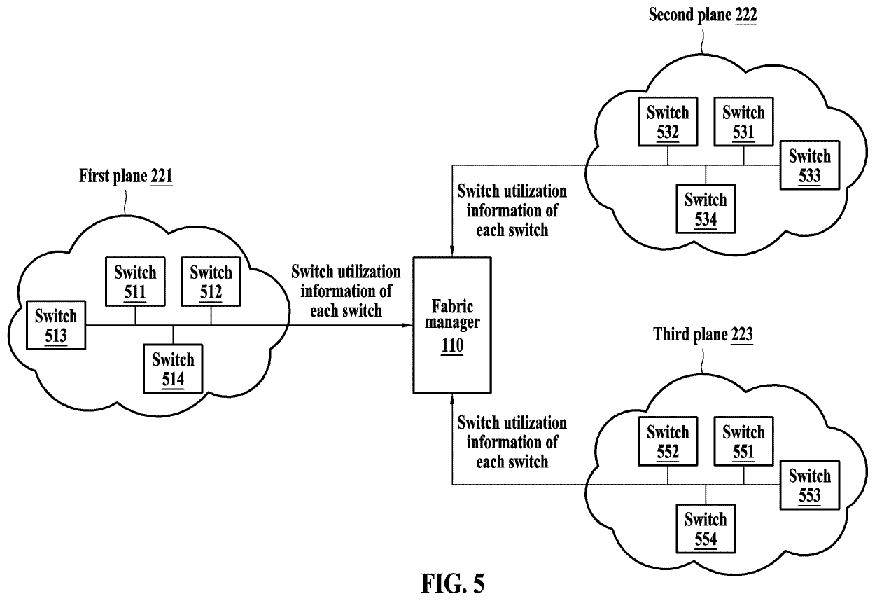

FIGS. 4 and 5 illustrate examples of an electronic device collecting pieces of plane utilization information. Operations 410 to 430 of FIG. 4 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 4, in operation 410, the electronic device 100 may obtain pieces of switch utilization information of each of switches in each of planes through the fabric manager 110. For example, in the example illustrated in FIG. 5, a switch 511 in the first plane 221 may determine switch utilization information of the switch 511. Here, the switch utilization information of the switch 511 may correspond to a value obtained by dividing the sum of amounts of data transmitted through each port of the switch 511 during a period by the sum of the maximum bandwidths of each port of the switch 511.

For example, the amount of data transmitted through the port 0 of the switch 511 during a period T may be a0 and the maximum bandwidth of the port 0 of the switch 511 may be b0, the amount of data transmitted through the port 1 of the switch 511 during the period T may be a1 and the maximum bandwidth of the port 1 of the switch 511 may be b1, and the amount of data transmitted through the port 2 of the switch 511 during the period T may be a2 and the maximum bandwidth of the port 2 of the switch 511 may be b2. In this case, the switch utilization information of the switch 511 during the period T may be (a0+a1+a2)/(T*b0+T*b1+T*b2). Here, * may be a multiplication symbol.

The switch 511 may transmit the switch utilization information of the switch 511 to the fabric manager 110. Similarly, each of other switches 512, 513, and 514 in the first plane 221 may determine pieces of switch utilization information of each of the switches 512, 513, and 514 during a period and may transmit, to the fabric manager 110, the pieces of switch utilization information of each of the switches 512, 513, and 514. Each of switches 531, 532, 533, and 534 in the second plane 222 may determine pieces of switch utilization information of each of the switches 531, 532, 533, and 534 during a period and may transmit, to the fabric manager 110, the pieces of switch utilization information of each of the switches 531, 532, 533, and 534. Each of switches 551, 552, 553, and 554 in the third plane 223 may determine pieces of switch utilization information of each of the switches 551, 552, 553, and 554 during a period and may transmit, to the fabric manager 110, the pieces of switch utilization information of each of the switches 551, 552, 553, and 554.

The fabric manager 110 may obtain (or receive) the pieces of switch utilization information of each of the switches 511, 512, 513, and 514 in the first plane 221. The fabric manager 110 may obtain (or receive) the pieces of switch utilization information of each of the switches 531, 532, 533, and 534 in the second plane 222. The fabric manager 110 may obtain (or receive) the pieces of switch utilization information of each of the switches 551, 552, 553, and 554 in the third plane 223.

Returning back to FIG. 4, in operation 420, the electronic device 100 may determine the pieces of plane utilization information of each of the planes through the fabric manager 110. The pieces of plane utilization information of each of the planes may correspond to, for example, information related to or indicating the utilization state of each of the planes. The pieces of plane utilization information of each of the planes may indicate the degree of busyness (or congestion) of each of the planes. For example, in the example illustrated in FIG. 5, the fabric manager 110 may determine, to be the plane utilization information of the first plane 221 during a period, the average of the pieces of switch utilization information obtained (or received) from each of the switches 511, 512, 513, and 514 in the first plane 221. The fabric manager 110 may determine, to be the plane utilization information of the second plane 222 during a period, the average of the pieces of switch utilization information obtained (or received) from each of the switches 531, 532, 533, and 534 in the second plane 222. The fabric manager 110 may determine, to be the plane utilization information of the third plane 223 during a period, the average of the pieces of switch utilization information obtained (or received) from each of the switches 551, 552, 553, and 554 in the third plane 223.

In operation 430, the electronic device 100 may transmit, to nodes, the pieces of plane utilization information of each of the planes. For example, the fabric manager 110 may transmit, to the first, second, third, and fourth nodes 231, 232, 233, and 234, the plane utilization information of the first plane 221 through the first plane 221. The fabric manager 110 may transmit, to the first, second, third, and fourth nodes 231, 232, 233, and 234, the plane utilization information of the second plane 222 through the second plane 222. The fabric manager 110 may transmit, to the first, second, third, and fourth nodes 231, 232, 233, and 234, the plane utilization information of the third plane 223 through the third plane 223. For example, the fabric manager 110 may transmit, to the nodes, the plane utilization information of a plane by transmitting the plane utilization information of the plane to the plane, and controlling the plane to further transmit the plane utilization information of the plane to the nodes.

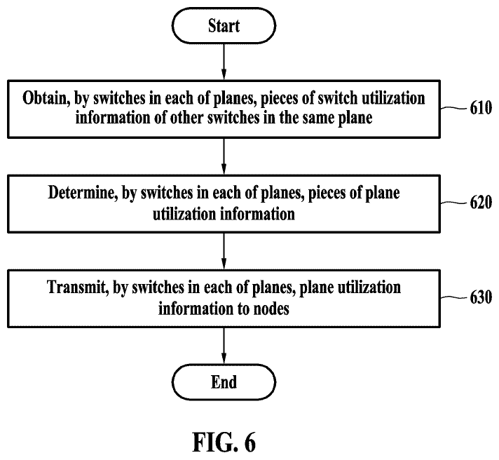

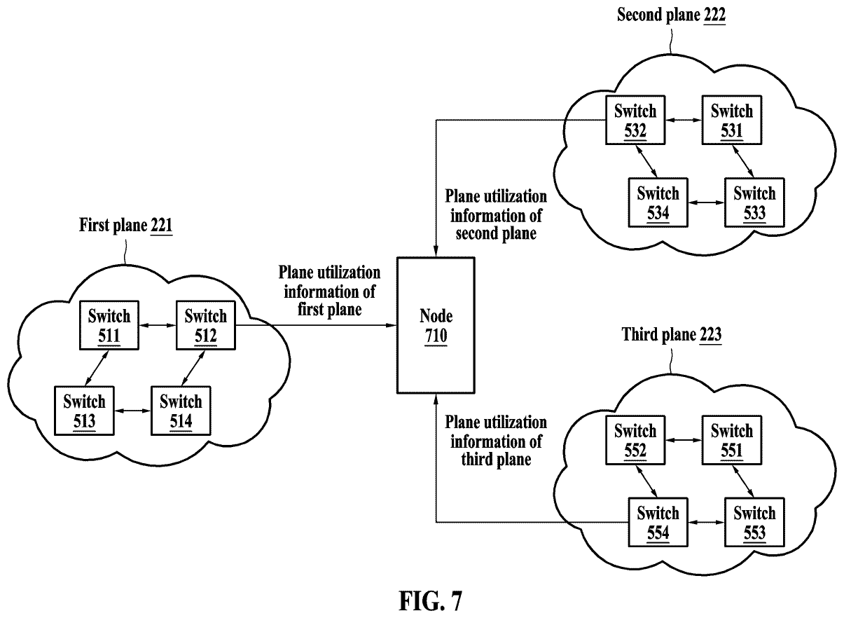

FIGS. 6 and 7 illustrate examples of an electronic device collecting pieces of plane utilization information. Operations 610 to 630 of FIG. 6 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 6, in operation 610, switches in each of planes of the electronic device 100 may obtain pieces of switch utilization information of other switches in the same plane. The switches in each of the planes of the electronic device 100 may exchange the pieces of switch utilization information with the other switches in the same plane.

For example, in the example illustrated in FIG. 7, the switches 511, 512, 513, and 514 in the first plane 221 may form a ring topology. However, examples are not limited thereto, and the switches 511, 512, 513, and 514 may form a bus topology, a fully connected topology, etc. Each of the switches 511, 512, 513, and 514 may obtain pieces of switch utilization information (e.g., pieces of switch utilization information during a period) of the other switches in the same plane (i.e., the first plane 221). For example, the switch 511 may obtain pieces of switch utilization information of each of the switches 512, 513, and 514. The switch 512 may obtain pieces of switch utilization information of each of the switches 511, 513, and 514. The switch 513 may obtain pieces of switch utilization information of each of the switches 511, 512, and 514. The switch 514 may obtain pieces of switch utilization information of each of the switches 511, 512, and 513.

The switches 531, 532, 533, and 534 in the second plane 222 of FIG. 7 may form a ring topology. Examples are not limited thereto, and the switches 531, 532, 533, and 534 may form a bus topology, a fully connected topology, etc. Each of the switches 531, 532, 533, and 534 may obtain pieces of switch utilization information (e.g., pieces of switch utilization information during a period) of the other switches in the same plane (i.e., the second plane 222). For example, the switch 531 may obtain pieces of switch utilization information of each of the switches 532, 533, and 534. The switch 532 may obtain pieces of switch utilization information of each of the switches 531, 533, and 534. The switch 533 may obtain pieces of switch utilization information of each of the switches 531, 532, and 534. The switch 534 may obtain pieces of switch utilization information of each of the switches 531, 532, and 533.

The switches 551, 552, 553, and 554 in the third plane 223 of FIG. 7 may form a ring topology. However, examples are not limited thereto, and the switches 551, 552, 553, and 554 may form a bus topology, a fully connected topology, etc. Each of the switches 551, 552, 553, and 554 may obtain pieces of switch utilization information (e.g., pieces of switch utilization information during a period) of the other switches in the same plane (i.e., the third plane 223). For example, the switch 551 may obtain pieces of switch utilization information of each of the switches 552, 553, and 554. The switch 552 may obtain pieces of switch utilization information of each of the switches 551, 553, and 554. The switch 553 may obtain pieces of switch utilization information of each of the switches 551, 552, and 554. The switch 554 may obtain pieces of switch utilization information of each of the switches 551, 552, and 553.

Returning back to FIG. 6, in operation 620, the switches in each of the planes of the electronic device 100 may determine the pieces of plane utilization information.

For example, in FIG. 7, the switch 511 in the first plane 221 may determine (or obtain) plane utilization information (e.g., plane utilization information during a period) of the first plane 221 by using the switch utilization information (e.g., the switch utilization information during a period) of the switch 511 and the pieces of switch utilization information (e.g., the pieces of switch utilization information during a period) of each of the switches 512, 513, and 514. The switch 512 may determine (or obtain) the plane utilization information (e.g., the plane utilization information during a period) of the first plane 221 by using the switch utilization information of the switch 512 and the pieces of switch utilization information of each of the switches 511, 513, and 514. The switch 513 may determine (or obtain) the plane utilization information (e.g., the plane utilization information during a period) of the first plane 221 by using the switch utilization information of the switch 513 and the pieces of switch utilization information of each of the switches 511, 512, and 514. The switch 514 may determine (or obtain) the plane utilization information (e.g., the plane utilization information during a period) of the first plane 221 by using the switch utilization information of the switch 514 and the pieces of switch utilization information of each of the switches 511, 512, and 513. Depending on the implementation, when a certain switch in the first plane 221 determines (or obtains) the plane utilization information (e.g., the plane utilization information during a period) of the first plane 221, the plane utilization information of the first plane 221 may be transmitted to the other switches in the first plane 221.

In FIG. 7, the switch 531 in the second plane 222 may determine (or obtain) the plane utilization information (e.g., the plane utilization information during a period) of the second plane 222 by using the switch utilization information of the switch 531 (e.g., the switch utilization information during a period) and the pieces of switch utilization information (e.g., the pieces of switch utilization information during a period) of each of the switches 532, 533, and 534. The switch 532 may determine (or obtain) the plane utilization information (e.g., the plane utilization information during a period) of the second plane 222 by using the switch utilization information of the switch 532 and the pieces of switch utilization information of each of the switches 531, 533, and 534. The switch 533 may determine (or obtain) the plane utilization information (e.g., the plane utilization information during a period) of the second plane 222 by using the switch utilization information of the switch 533 and the pieces of switch utilization information of each of the switches 531, 532, and 534. The switch 534 may determine (or obtain) the plane utilization information (e.g., the plane utilization information during a period) of the second plane 222 by using the switch utilization information of the switch 534 and the pieces of switch utilization information of each of the switches 531, 532, and 533. Depending on the implementation, when a certain switch in the second plane 222 determines (or obtains) the plane utilization information (e.g., the plane utilization information during a period) of the second plane 222, the plane utilization information of the second plane 222 may be transmitted to the other switches in the second plane 222.

Similar to the first plane 221 and the second plane 222, each of the switches 551, 552, 553, and 554 in the third plane 223 may determine (or obtain) the plane utilization information of the third plane 223.

In operation 630, the switches in each of the planes of the electronic device 100 may transmit the plane utilization information to nodes. For example, in the example illustrated in FIG. 7, the switch 512 in the first plane 221 may transmit the plane utilization information of the first plane 221 to a node 710 (e.g., the first node 231) connected to the switch 512. The node 710 may receive the plane utilization information of first plane 221 from the switch 512 through a first port (e.g., the port 0 of FIG. 2). The switch 532 in the second plane 222 may transmit the plane utilization information of the second plane 222 to the node 710 (e.g., the first node 231) connected to the switch 532. The node 710 may receive the plane utilization information of the second plane 222 from the switch 532 through a second port (e.g., the port 1 of FIG. 2). The switch 554 in third plane 223 may transmit the plane utilization information of the third plane 223 to the node 710 (e.g., the first node 231) connected to the switch 554. The node 710 may receive the plane utilization information of the third plane 223 from the switch 554 through a third port (e.g., the port 2 of FIG. 2).

Although not illustrated in FIG. 7, the switch 512 in the first plane 221, the switch 532 in the second plane 222, and the switch 554 in the third plane 223 may be connected to the second node 232, the third node 233, and the fourth node 234, respectively. The switch 512 in the first plane 221 may transmit the plane utilization information of the first plane 221 to the second node 232, the third node 233, and the fourth node 234. The switch 532 in the second plane 222 may transmit the plane utilization information of the second plane 222 to the second node 232, the third node 233, and the fourth node 234. The switch 554 in the third plane 223 may transmit the plane utilization information of the third plane 223 to the second node 232, the third node 233, and the fourth node 234.

Although not illustrated in FIG. 7, each of the switches 511, 513, and 514 in the first plane 221 may transmit the plane utilization information of the first plane 221 to at least one node connected to each of the switches 511, 513, and 514. Each of the switches 531, 533, and 534 in the second plane 222 may transmit the plane utilization information of the second plane 222 to at least one node connected to each of the switches 531, 533, and 534. Each of the switches 551, 553, and 554 in the third plane 223 may transmit the plane utilization information of the third plane 223 to at least one node connected to each of the switches 551, 553, and 554.

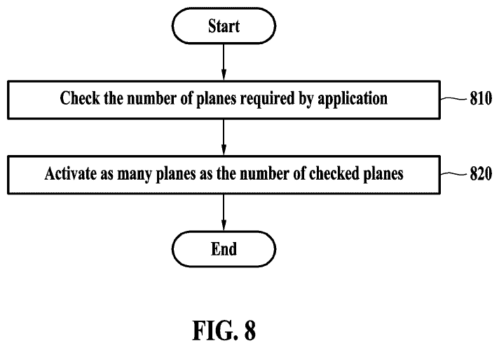

FIG. 8 illustrates an example of an operation of an electronic device activating planes. Operations 810 and 820 of FIG. 8 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 8, in operation 810, the electronic device 100 may check the number of planes to be used to implement (e.g., required by) an application. The number of planes may be related to a network bandwidth so that the electronic device 100 may check a required bandwidth of the application to activate planes that satisfy the required bandwidth of the application. The application may include, for example, a first application that trains a large language model (LLM), a second application that is computationally oriented (e.g., high-performance conjugate gradient (HPCG)), and the like. The first application may require a first number of planes (e.g., 16). That is, the execution of the first application may require the first number of planes. The second application may require a second number of planes (e.g., 4). That is, the execution of the second application may require the second number of planes.

For example, the fabric manager 110 may receive an execution request for the application from a user. The fabric manager 110 may check the number of planes required by the application having the execution request. For example, when there is an execution request for the first application, the fabric manager 110 may check that the first application requires the first number of planes. When there is an execution request for the second application, the fabric manager 110 may check that the second application requires the second number of planes.

In operation 820, the electronic device 100 may activate as many planes as the number of checked planes. For example, the fabric manager 110 may activate as many planes as a first number in response to the execution request for the first application requiring the first number of planes being received. The fabric manager 110 may activate as many planes as a second number in response to the execution request for the second application requiring the second number of planes being received.

The electronic device 100 may activate all or some of the planes of the electronic device 100 based on the required bandwidth of the application having the execution request. The fabric manager 110 may activate all the planes of the electronic device 100 when the required bandwidth of the application is greater than or equal to a threshold bandwidth (e.g., 256 gigabytes per second (Gbps)). The electronic device 100 may deactivate at least some of the planes of the electronic device 100 when the required bandwidth of the application is less than the threshold bandwidth.

The electronic device 100 may monitor the amount of network loads of the application. The electronic device 100 may deactivate at least one of the activated planes when the amount of network loads is less than a predetermined level. For example, when there is an execution request for the first application, the electronic device 100 may activate as many planes as the first number and may transmit and receive data through the activated planes. The electronic device 100 may deactivate at least one of the first number of activated planes when the amount of network loads is less than the predetermined level. The electronic device 100 may dynamically adjust the number of active planes by considering the amount of network loads.

The electronic device 100 of one or more embodiments may reduce power consumption by adjusting the number of active planes by considering (e.g., based on) a characteristic of the application (e.g., the number of planes required by the application (or the required bandwidth of the application), the amount of network loads generated by the execution of the application, and the like).

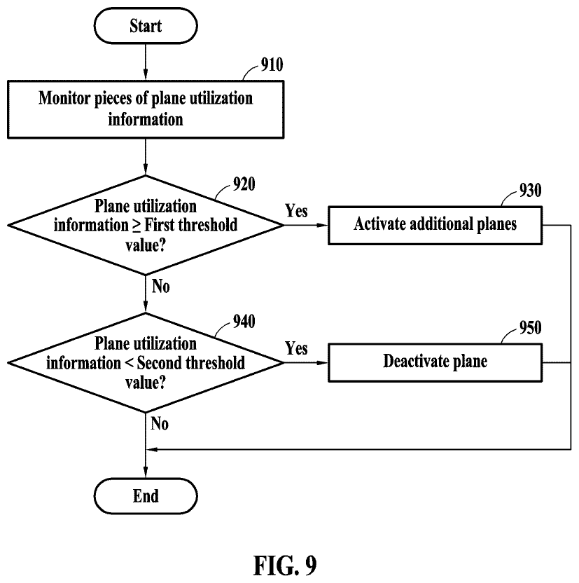

FIG. 9 illustrates an example of an operation of an electronic device activating and deactivating planes. Operations 910 to 950 of FIG. 9 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 9, in operation 910, the electronic device 100 (e.g., the fabric manager 110) may monitor the pieces of plane utilization information of each of the first, second, and third planes 221, 222, and 223. The electronic device 100 (e.g., the fabric manager 110) may monitor the pieces of plane utilization information of each of the first, second, and third planes 221, 222, and 223 for each period.

In operation 920, the electronic device 100 (e.g., the fabric manager 110) may determine whether the plane utilization information (e.g., the plane utilization information during a period) is greater than or equal to a first threshold value (e.g., 0.7 (or 70%)). For example, the electronic device 100 (e.g., the fabric manager 110) may determine whether the pieces of plane utilization information (e.g., the pieces of plane utilization information during a period) of each of activated planes are greater than or equal to the first threshold value (e.g., 0.7 (or 70%)). The plane utilization information of 1 (or 100%) may indicate that a plane is being utilized to the maximum.

In operation 930, the electronic device 100 (e.g., the fabric manager 110) may activate additional planes when the plane utilization information (e.g., the plane utilization information during a period) of at least one of the activated planes is greater than or equal to the first threshold value. For example, 10 planes may be activated in a first period, and the plane utilization information of at least one of the activated planes may be greater than or equal to the first threshold value during the first period. In this case, the electronic device 100 (e.g., the fabric manager 110) may activate one or more additional planes. 11 or more planes may be activated in a second period (i.e., the next period of the first period).

When the pieces of plane utilization information (e.g., the pieces of plane utilization information during a period) of each of the activated planes are less than the first threshold value, in operation 940, the electronic device 100 (e.g., the fabric manager 110) may determine whether the pieces of plane utilization information are less than a second threshold value (e.g., 0.2 (or 20%)). The electronic device 100 (e.g., the fabric manager 110) may determine whether the pieces of plane utilization information of each of the activated planes are less than the second threshold value.

In operation 950, the electronic device 100 (e.g., the fabric manager 110) may deactivate a plane having the plane utilization information that is less than the second threshold value when the plane utilization information of one of the activated planes is less than the second threshold value. The electronic device 100 (e.g., the fabric manager 110) may turn off switches in the plane having the plane utilization information that is less than the second threshold value. For example, 10 planes may be activated in the first period, and the pieces of plane utilization information of each of two planes of the activated planes may be less than the second threshold value during the first period. In this case, the electronic device 100 (e.g., the fabric manager 110) may turn off switches of each of the two planes having the plane utilization information that is less than the second threshold value.

The electronic device 100 (e.g., the fabric manager 110) may maintain the activated state of the activated planes when the pieces of plane utilization information of each of the activated planes are greater than or equal to the second threshold value and less than the first threshold value.

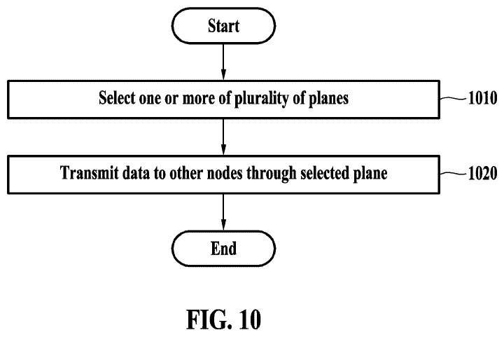

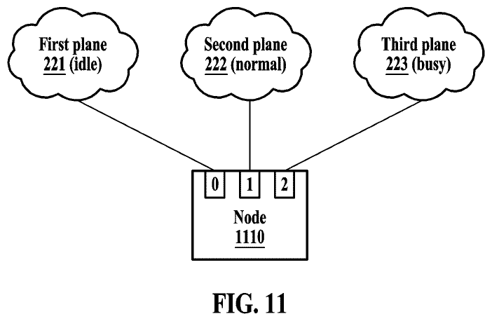

FIGS. 10 and 11 illustrate examples of an operation of a node in an electronic device. Operations 1010 and 1020 of FIG. 10 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 10, in operation 1010, a node in the electronic device 100 may select one or more of a plurality of planes. For example, in the example illustrated in FIG. 11, a node 1110 (e.g., the first node 231) in the electronic device 100 may select one or more of the plurality of planes by using the pieces of plane utilization information of each of the first, second, and third planes 221, 222, and 223. In the example illustrated in FIG. 11, the utilization state of the first plane 221 may be in an idle state, the utilization state of the second plane 222 may be in a normal state, and the utilization state of the third plane 223 may be in a busy state. The idle state may indicate that a plane is in an activated state but the utilization level is low. When the plane utilization information is greater than or equal to a second threshold value (e.g., 0.2 (or 20%)) and less than a third threshold value (e.g., 0.3 (or 30%)), the utilization state of a plane may correspond to an idle state. The normal state may be a state in which the degree of utilization of a plane is higher than that of the idle state. When the plane utilization information is greater than or equal to the third threshold value and less than a first threshold value (e.g., 0.7 (or 70%)), the utilization state of a plane may correspond to a normal state. The busy state may be a state in which the degree of utilization of a plane is higher than that of the normal state. The utilization state of the plane may correspond to a busy state when the plane utilization information is greater than or equal to the first threshold value. In an example, operation 1010, the node may select a plane of the plurality of planes having the lowest utilization information. In another example, operation 1010, when two or more planes of the plurality of planes have a utilization state corresponding to the idle state, the node may select a plane of the two or more planes having the lowest utilization information.

The node 1110 may select the first plane 221 among the first, second, and third planes 221, 222, and 223, which is in an idle state.

In operation 1020, the node in the electronic device 100 may transmit data to other nodes through the selected plane. The node 1110 of FIG. 11 may transmit data to nodes (e.g., the second node 232, the third node 233, and the fourth node 234) through the first plane 221. For example, the node 1110 may transmit data to the first plane 221 through the port 0, and the first plane 221 may transmit data of the node 1110 to at least one of or all the nodes connected to the first plane 221.

When a typical node transmits data to all the first, second, and third planes 221, 222, and 223, a speed decrease (e.g., a straggler) may occur. For example, the third plane 223 may be in a busy state, and thus, the third plane 223 may transmit the data of the node 1110 later than other planes. As a result, a speed decrease may occur when the typical node transmits the data to all the first, second, and third planes 221, 222, and 223. In contrast, the node 1110 of one or more embodiments may check whether the first plane 221 is relatively free compared to the other planes through the pieces of plane utilization information of each of the first, second, and third planes 221, 222, and 223 and may transmit the data to the first plane 221, thereby preventing the speed decrease from occurring.

The description of the node 1110 may be applied to the nodes included in the electronic device 100.

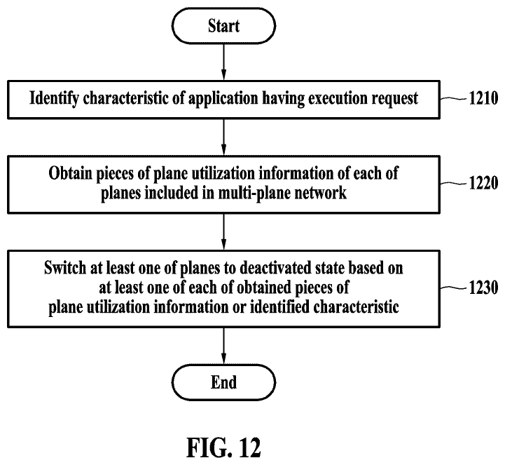

FIG. 12 illustrates an example of an operating method (or a multi-plane network management method) of an electronic device. Operations 1210 to 1230 of FIG. 12 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 12, in operation 1210, the electronic device 100 may identify a characteristic of an application (e.g., a required bandwidth of an application, the amount of network loads of the application, and the like) having an execution request.

In operation 1220, the electronic device 100 may obtain pieces of plane utilization information of each of planes included in the multi-plane network 120.

For example, the fabric manager 110 of the electronic device 100 may receive, from switches of each of the planes, pieces of switch utilization information of each of the switches of each of the planes and may determine pieces of plane utilization information of each of the planes based on the pieces of switch utilization information of each of the switches of each of the planes. In another example, a first switch of each of the planes of the electronic device 100 may obtain switch utilization information from other switches in the same plane. The first switch of each of the planes may determine the pieces of plane utilization information of each of the planes by using switch utilization information of the first switch of each of the planes and the pieces of switch utilization information of the other switches in the same plane. In the example illustrated in FIG. 7, the first switch (e.g., the switch 512) of the first plane 221 may determine the plane utilization information of the first plane 221 by using the switch utilization information of the first switch (e.g., the switch 512) and the pieces of switch utilization information of the other switches in the same plane. The first switch (e.g., the switch 532) of the second plane 222 may determine plane utilization information of the second plane 222 by using the switch utilization information of the first switch (e.g., the switch 532) of the second plane 222 and the pieces of switch utilization information of the other switches in the same plane. The first switch (e.g., the switch 554) of the third plane 223 may determine plane utilization information of the third plane 223 by using the switch utilization information of the first switch (e.g., the switch 554) of the third plane 223 and the pieces of switch utilization information of the other switches in the same plane.

In operation 1230, the electronic device 100 may switch at least one of the planes to a deactivated state based on at least one of each of the obtained pieces of plane utilization information and/or the identified characteristic of the application. For example, the electronic device 100 may determine whether each of the obtained pieces of plane utilization information is less than a second threshold value and may switch, to the deactivated state, a plane having plane utilization information that is less than the second threshold value. The electronic device 100 may switch at least one of the planes to the deactivated state when a required bandwidth is less than a threshold bandwidth. The electronic device 100 may switch, to the deactivated state, at least one of the planes (e.g., the planes in an activated state) when the amount of network loads of the application is less than the amount of threshold loads.

The electronic device 100 may determine whether the pieces of plane utilization information of each of the planes in the activated state are greater than or equal to a first threshold value. When the plane utilization information of at least one of the planes in the activated state is greater than or equal to the first threshold value, the electronic device 100 may switch a plane in the deactivated state to the activated state.

The electronic device 100 may transmit each of the obtained pieces of plane utilization information to a node in the electronic device 100. The node may select one of the planes using each of received pieces of plane utilization information and may transmit data to other nodes through the selected plane.

The description provided with reference to FIGS. 1 to 11 may be applied to the operating method of the electronic device 100 of FIG. 12.

The electronic devices, fabric managers, multi-plane networks, nodes, planes, switches, electronic device 100, fabric manager 110, multi-plane network 120, nodes 130, 231, 232, 233, 234, 710, and 1110, planes 221, 222, and 223, and switches 311, 312, 313, 314, 511, 512, 513, 514, 531, 532, 533, 534, 551, 552, 553, and 554 described herein, including descriptions with respect to respect to FIGS. 1-12, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-12 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
identifying a characteristic of an application having an execution request;
obtaining pieces of plane utilization information of each of planes of a multi-plane network, wherein the pieces of plane utilization information of each of the planes correspond to information related to a utilization state of each of the planes; and
switching one or more of the planes to a deactivated state based on either one or both of the identified characteristic and each of the obtained pieces of plane utilization information.

2. The method of claim 1, further comprising:
determining whether pieces of plane utilization information of each of planes in an activated state are greater than or equal to a first threshold value; and
switching a plane in a deactivated state to an activated state in response to plane utilization information of one or more of the planes in the activated state being greater than or equal to the first threshold value.

3. The method of claim 1, wherein the switching of the one or more of the planes comprises:
determining whether the each of the obtained pieces of plane utilization information is less than a second threshold value; and
switching, to the deactivated state, a plane having plane utilization information that is less than the second threshold value.

4. The method of claim 1, wherein
the characteristic comprises a required bandwidth of the application, and
the switching of the one or more of the planes comprises switching the one or more of the planes to the deactivated state in response to the required bandwidth being less than a threshold bandwidth.

5. The method of claim 1, wherein
the characteristic comprises an amount of network loads of the application, and
the switching of the one or more of the planes comprises switching the one or more of the planes to the deactivated state in response to the amount of network loads being less than or equal to an amount of threshold loads.

6. The method of claim 1, further comprising transmitting the each of the obtained pieces of plane utilization information to a node in an electronic device.

7. The method of claim 6, wherein the node is configured to select a plane among the planes using each of received pieces of plane utilization information and configured to transmit data to other nodes in the electronic device through the selected plane.

8. The method of claim 1, wherein the obtaining of the pieces of plane utilization information comprises:
receiving, from switches of each of the planes, pieces of switch utilization information of each of the switches of each of the planes; and
determining the pieces of plane utilization information of each of the planes based on the pieces of switch utilization information of each of the switches of each of the planes.

9. The method of claim 8, wherein the pieces of switch utilization information of each of the switches of each of the planes are determined based on a sum of amounts of data transmitted by each of the switches of each of the planes through ports during a predetermined period and a sum of bandwidths of the ports.

10. The method of claim 1, wherein the obtaining of the pieces of plane utilization information comprises:
obtaining, from other switches in the same plane, pieces of switch utilization information by a first switch of each of the planes; and
determining the pieces of plane utilization information of each of the planes by the first switch of each of the planes by using switch utilization information of the first switch of each of the planes and the pieces of switch utilization information of the other switches in the same plane.

11. An electronic device comprising:
one or more processors configured to:
identify a characteristic of an application having an execution request;
obtain pieces of plane utilization information of each of planes of a multi-plane network, wherein the pieces of plane utilization information of each of the planes correspond to information related to a utilization state of each of the planes; and
switch one or more of the planes to a deactivated state based on either one or both of the identified characteristic and each of the obtained pieces of plane utilization information.

12. The electronic device of claim 11, wherein the one or more processors are configured to:
determine whether pieces of plane utilization information of each of planes in an activated state are greater than or equal to a first threshold value; and
switch a plane in a deactivated state to an activated state in response to plane utilization information of one or more of the planes in the activated state being greater than or equal to the first threshold value.

13. The electronic device of claim 11, wherein, for the switching of the one or more of the planes, the one or more processors are configured to:
determine whether the each of the obtained pieces of plane utilization information is less than a second threshold value; and
switch, to the deactivated state, a plane having plane utilization information that is less than the second threshold value.

14. The electronic device of claim 11, wherein
the characteristic comprises a required bandwidth of the application, and
for the switching of the one or more of the planes, the one or more processors are configured to switch the one or more of the planes to the deactivated state in response to the required bandwidth being less than a threshold bandwidth.

15. The electronic device of claim 11, wherein
the characteristic comprises an amount of network loads of the application, and
for the switching of the one or more of the planes, the one or more processors are configured to switch the one or more of the planes to the deactivated state in response to the amount of network loads being less than or equal to an amount of threshold loads.

16. The electronic device of claim 11, wherein the one or more processors are configured to transmit the each of the obtained pieces of plane utilization information to a node in the electronic device.

17. The electronic device of claim 16, wherein the node is configured to select a plane among the planes using each of received pieces of plane utilization information and transmit data to other nodes in the electronic device through the selected plane.

18. The electronic device of claim 11, wherein, for the obtaining of the pieces of plane utilization information, the one or more processors are configured to receive, from switches of each of the planes, pieces of switch utilization information of each of the switches of each of the planes and configured to determine the pieces of plane utilization information of each of the planes based on the pieces of switch utilization information of each of the switches of each of the planes.

19. The electronic device of claim 18, wherein the pieces of switch utilization information of each of the switches of each of the planes are determined based on a sum of amounts of data transmitted by each of the switches of each of the planes through ports during a predetermined period and a sum of bandwidths of the ports.

20. The electronic device of claim 11, wherein, for the obtaining of the pieces of plane utilization information, a first switch of each of the planes is configured to obtain, from other switches in the same plane, pieces of switch utilization information and configured to determine the pieces of plane utilization information of each of the planes by the first switch of each of the planes by using switch utilization information of the first switch of each of the planes and the pieces of switch utilization information of the other switches in the same plane.
